(19) United States
(12) Patent Application Publication
(10) Pub. No.: US 2010/0010895 A1
(43) Pub. Date: Jan. 14, 2010

(54) PREDICTION OF A DEGREE OF RELEVANCE BETWEEN QUERY REWRITES AND A SEARCH QUERY

(75) Inventors: Evgeniy Gabrilovich, Sunnyvale, CA (US); Donald Metzler, Santa Clara, CA (US); Vanja Josifovski, Los Gatos, CA (US); Andrei Broder, Menlo Park, CA (US); Vassilis Plachouras, Barcelona (ES); Vanessa Murdock, Barcelona (ES); Massimiliano Ciaramita, Barcelona (ES)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/169,218

(22) Filed: Jul. 8, 2008

(51) Int. Cl. G06Q 30/00; G06F 17/30; G06F 7/06

(52) U.S. Cl. 705/14.54; 707/4; 707/E17.014

(57) ABSTRACT

A predictor for determining a degree of relevance between a query rewrite and a search query is provided. The predictor may receive a search query from a user via a terminal and identify a set of candidate query rewrites associated with the search query. The predictor may then extract a set of features from advertisements associated with the query rewrites and the search query and determine a degree of relevance between the advertisements and the search query based on a prediction model. The predictor may then determine the degree of relevance between the rewrites and the search query based on the determined degree of relevance between the advertisements and the search query.

### BACKGROUND

Online advertisement service providers (ad providers), such as Yahoo! Inc., serve advertisements for placement on a webpage based on bid phrases associated with advertisements and keywords within search queries received at a sponsored search web server. In some instances, ad providers may rely on query rewrites to provide broader search coverage. A query rewrite corresponds to a set of terms that may relate to the original search query to varying degrees. When query rewrites are utilized, advertisements associated with keywords within the query rewrites may be served as well.

However, as noted above, the relatedness or relevance between a search query and a query rewrite may vary. That is, some query rewrites may be more relevant to the original search query than others. For example, the rewrite “automobile” may be more related or relevant to the search query “car” than the rewrite “travel.” Serving advertisements based on rewrites that are not relevant to a search query both frustrates advertisers, whose advertisements are not being displayed to interested potential customers, and users who are viewing advertisements that are not relevant to a submitted search query.

### BRIEF DESCRIPTION OF THE DRAWINGS

FIG. 1 is a diagram of a system for predicting a degree of relevance between query rewrites and a search query;

FIG. 2 is a flow diagram describing an operation of the system in FIG. 1 in a first embodiment;

FIG. 3 is a flow diagram describing an operation of the system in FIG. 1 in a second embodiment;

FIG. 4 is a flow diagram for predicting a degree of relevance between a search query and advertisements associated with a query rewrite;

FIG. 5 is a flow chart for generating a prediction model to predict a degree of relevance between advertisements and search queries; and

FIG. 6 illustrates a general computer system, which may represent a sponsored search web server, terminal, or any of the other computing devices referenced herein.

### DETAILED DESCRIPTION OF THE DRAWINGS

The present disclosure is directed to systems and methods for predicting a degree of relevance between query rewrites and a search query. Determining a degree of relevance between a query rewrite and a search query before serving the advertisements based on the query rewrite allows an ad provider to improve the accuracy of the advertisements it serves. By improving the accuracy of served advertisements, advertiser satisfaction with the ad provider is increased because the advertisements of the advertiser are being displayed to interested customers. Additionally, improving the accuracy of served advertisements increases user satisfaction because the users are being shown advertisements for products or services in which the user may actually be interested.

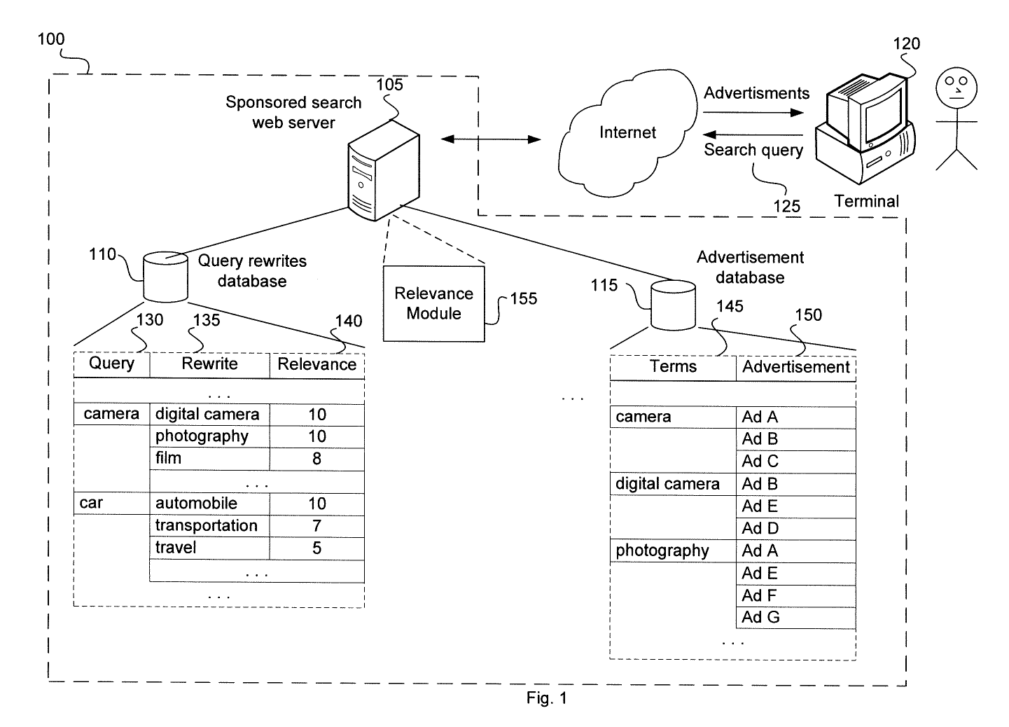

FIG. 1 is a diagram of a system 100 for predicting a degree of relevance between query rewrites and a search query. The system 100 includes a sponsored search web server 105 in communication with a query rewrite database 110, an advertisement database 115, and a relevance module 155. Also shown is a terminal 120 that communicates with the system.

The sponsored search web server 105 may include suitable logic, code, and/or circuitry that may enable generating web pages, including sponsored search web pages with a search result list and a list of advertisements. The search result list and list of advertisements may be associated with a search query 125 communicated from the terminal 120. The sponsored search web server 105 may correspond to an Intel® based computer running applications such as Apache® or Microsoft Internet Information Server®, which may be utilized to generate the web pages. The sponsored search web server 105 may be implemented using any conventional computer or other data processing device. The sponsored search web server 105 may further be implemented using a specialized data processing device which has been particularly adapted to perform the functions of a sponsored search web server 105. These functions may include communicating with a user operating an Internet browser running on a terminal 125. The sponsored search web server 105 may also be adapted to communicate with other networked equipment and to retrieve information from various databases, such as a query rewrite database 110, and/or an advertisement database 115.

The terminal 120 may include suitable logic, code, and/or circuitry that may enable communicating information over a network connection, such as an Internet connection. For example, the terminal 120 may correspond to an Intel® based computer running a Windows® operating system with a browser, such as Internet Explorer®. The terminal 120 may be adapted to communicate a search query 125 to the sponsored search web server 115 and to display web pages communicated from a web server, such as a search result list generated by a sponsored search web server 105.

The query rewrite database 110 may include information for relating a query terms 130 from a search query 125 specified by a user at the terminal 125 to rewrites 135. The query rewrite database 110 may also include information corresponding to a relevance attribute 140 for specifying the degree to which a query term 130 and a rewrite 135 relate to one another. For example, a search query 125 with the query term 130 “camera” may be related to the rewrites 135 “digital camera”, “photography”, and “film”, as shown in FIG. 1. It may be the case that the rewrite 135 “digital camera” is more related or relevant to the query term 130 “camera” than the rewrite 135 “film.” In this case, the relevance attribute 140 for “digital camera” may be higher than the relevance attribute 140 for “film.”

The advertisement database 115 may include information for associating terms 145 with a plurality of advertisements 150. The terms 145 may correspond to terms in a search query 125 specified by a user at the terminal 120 and/or rewrites 135 stored in the query rewrite database 110 that are associated with search queries 125. Advertisements 150 may have been previously associated with the terms 145 via, for example, a bidding process where advertisers bid on keywords or terms 145. The information communicated from the advertisement database 115 may include data defining text, images, video, audio or other information, such as links to another computer database include the advertisement data.

The relevance module may include suitable logic, code, and/or circuitry that may enable predicting the relevance between a query term and a query rewrite and also for predicting the relevance between a query term and an advertisement. The relevance module 155 may reside within the sponsored search web server 105 or in another computer (not shown) in communication with the sponsored search web server and/or the query rewrites database 110 and advertisement database 115. In this regard, the relevance module may be utilized to specify the relevance attribute 140 associated with a query term 130 and a rewrite 135 located in the query rewrite database 110.

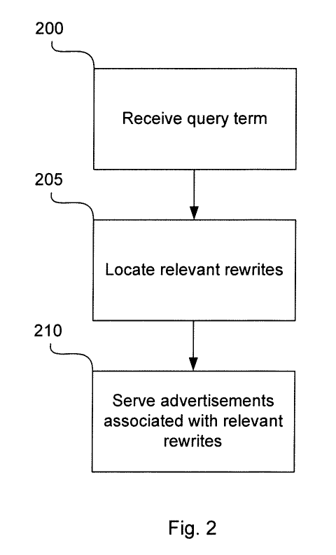

FIG. 2 is a flow diagram describing an operation of the system 100 (FIG. 1) in a first embodiment. At block 200, the system 100 may receive a search query. For example, with reference to FIG. 1 a user at a terminal 120 may navigate to a sponsored search web page hosted by the sponsored search web server 105 and specify a search query 125, such as “camera.” At block 205, relevant rewrites may be located. For example, the sponsored search web server 105 may search through a query rewrite database 110 to locate query rewrites related or relevant to the search query “camera” specified by the user. In this case, the rewrites “digital camera”, “photography”, and “film” may be located. At block 210, advertisements associated with the relevant rewrites may be served or delivered. For example, the sponsored search web server 105 may serve or deliver advertisements specified in the advertisement database 115 and associated with the rewrites “digital camera”, “photography”, and “film” to the user at the terminal 120 as part of a sponsored search result web page. In some instances where advertising space may be limited, the number of rewrites utilized may be limited to those that have the highest relevance. At least one advantage of this approach is that relevant rewrites are utilized. This helps ensure that the advertisements presented to the user at the terminal 120 are better targeted.

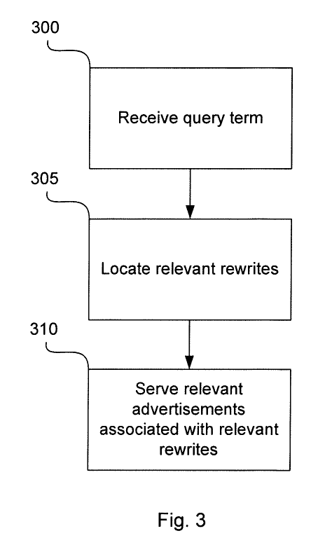

FIG. 3 is a flow diagram describing an operation of the system 100 (FIG. 1) in a second embodiment. At block 300, the system 100 may receive a search query and at block 305, relevant rewrites may be located as described above with reference to FIG. 2. At block 310, relevant advertisements associated with the relevant rewrites may be retrieved and delivered to the user as part of a sponsored search result web page. In doing so, a determination may be made as to whether an advertisement associated with a rewrite is relevant to the original search query. Once the determination is made, the relevant advertisements may be served or delivered to the user at the terminal 120. This approach improves the targeting of the advertisements further because the advertisements served are the relevant advertisements of the relevant rewrites rather than the non-relevant advertisements of the relevant rewrites.

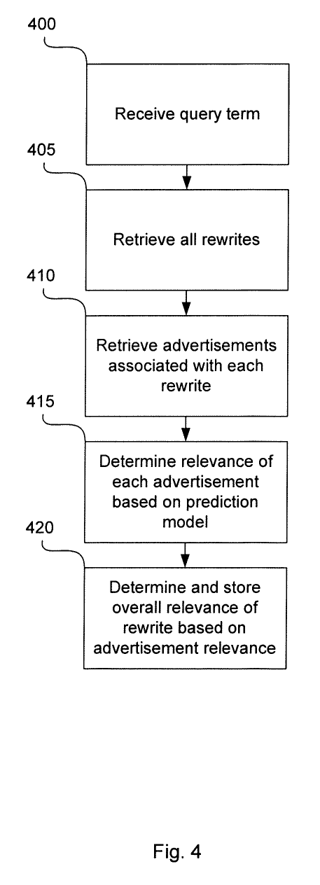

FIG. 4 is a flow diagram for predicting a degree of relevance between a search query and advertisements associated with a query rewrite. At block 400, a search query may be received. For example, with reference to FIG. 1, a user at a terminal 120 may specify a search query 125 via a sponsored search web page hosted by a sponsored search web server 105. At block 405, all the rewrites associated with the search query 125 may be retrieved. The rewrites may have been previously associated with the search query 125 by human operators or via statistical processes for associating rewrites with the search queries. For example, the choice of key words selected by advertisers for an advertisement may be utilized to generate the rewrites.

At block 410, a plurality of advertisements associated with each rewrite may be retrieved. The plurality of advertisements may have been previously associated with the rewrites by human operators or automatically. For example, an advertiser may have bid on key words within the rewrite. In doing so, the advertiser's advertisements may become associated with the rewrite.

At block 415, the relevance between each advertisement of the plurality of advertisements and the received search query may be determined by extracting a set of features indicative of the relatedness of the advertisement and the search query and passing the extracted features through a prediction module for predicting the relevance. The prediction module corresponds to a parameterized set of features belonging to advertisements and search queries of known relatedness to one another. The relatedness or relevance between a new advertisement and new search query may be determined by comparing the features extracted from the new advertisement and new search query to the features extracted from advertisements and search queries of known relatedness to one another. At block 420, the overall relevance between the rewrite and the received search query may be determined based on the relevance between the plurality of advertisements associated with the rewrite and the original search query. For example, the relevance between the rewrite and the received search query may correspond to the average relevance between all the advertisements associated with the rewrite and the search query. After determining, the relevance between the rewrite and the received query, the value corresponding to the relevance may be stored in a database, such as the query rewrite database 110 shown in FIG. 1.

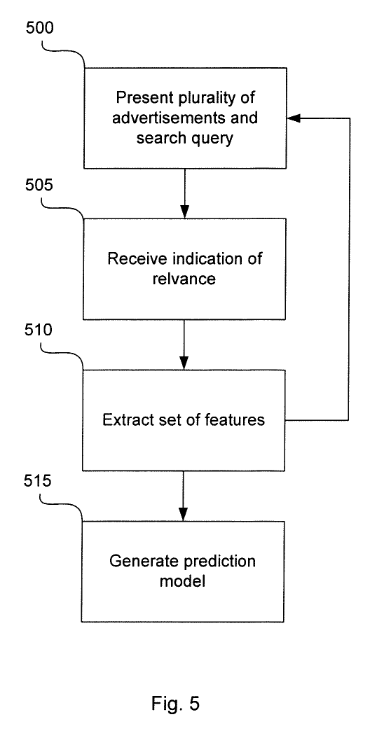

FIG. 5 is a flow chart for generating a prediction model to predict a degree of relevance between advertisements and search queries. At block 500, a training set may be constructed by presenting a plurality of advertisements and search queries to a human operator and receiving an indication from the human operator at block 505 as to whether the presented plurality of advertisements are relevant to the search queries. In some implementations, the human operator may indicate that the plurality of advertisements is relevant to a query or is not relevant to the query. However, in other implementations the human operator may indicate a degree of relevance between the plurality of advertisements and the query on a scale, such as zero to ten.

In other implementations, rather than presenting a human operator with a plurality of advertisements and query at block 500 and receiving an indication of relevance at block 505, a system, such as the system 100 shown in FIG. 1 may implicitly determine a degree of relevance between the plurality of advertisements and the queries based on click-through information available in sources such as search logs. For example, if Internet users typically click on an advertisement when displayed in response to a given search query, the system 100 may infer that the advertisement is relevant to the search query.

At block 510, a set of features may be extracted from the advertisements and search queries via the relevance module 155 shown in FIG. 1. A feature typically measures the relatedness or a degree of relevance between the advertisements and search query, measures an overall quality of the advertisements, or measures a relationship between the advertisements themselves. In one implementation, the set of features may include information regarding an advertisement and/or search query with respect to word overlap, cosine similarity, translation, pointwise mutual information, chi-squared, bid price, score coefficient of variation, and topical cohesiveness, each of which is described below.

Word overlap is a feature that measures a degree to which terms, also known as keywords or bid phrases, associated with the plurality of advertisements overlap with terms in the content of the search query. For each advertisements of the plurality of advertisements, the relevance module may create a word overlap score based on whether all the terms associated with the advertisement are present in the content of the search query, whether none of the terms associated with the advertisement are present in the content of the search query, or a proportion of the terms associated with the advertisement that are present in the content of the search query. The word overlap score of each advertisement is then aggregated to calculate a word overlap score of the plurality of advertisements and the content of the search query.

In some implementations, for a feature X measuring a degree of relevance between advertisements and search query content such as the word overlap feature, the relevance module may calculate four values associated with the feature using the equations:

$${X}_{min} ( P , A ) = {min}_{α ∈ A} X ( P , A )$$

$${X}_{max} ( P , A ) = {max}_{α ∈ A} X ( P , A )$$

$${X}_{mean} ( P , A ) = {\sum }_{α ∈ A} \frac{X ( P , A )}{\vert A \vert}$$

$${X}_{wmean} ( P , A ) = {\sum }_{α ∈ A} \frac{SCORE ( P , A ) \cdot X ( P , A )}{{\sum }_{{α}^{′} ∈ A} SCORE ( Q , {A}^{′} )} I$$

where A is the plurality of advertisements, P is the search query, and SCORE(P,A) is an ad score returned by an ad provider for an advertisement with respect to terms from the search query. An ad score is typically a measure of the degree of relevance between an advertisement and a keyword.

Xₘᵢₙ(P,A) results in a minimum feature value associated with an advertisement of the plurality of advertisements and search query content. For example, a plurality of advertisements may include a first advertisement, a second advertisement, a third advertisement, a fourth advertisement, and a fifth advertisement. The first advertisement is associated with a word overlap score of 1, the second advertisement is associated with a word overlap score of 2 the third advertisement is associated with a word overlap score of 3, the fourth advertisement is associated with a word overlap score of 4, and the fifth advertisement is associated with a word overlap score of 5. Accordingly, the Xₘᵢₙ(P,A) of the word overlap feature for the plurality of advertisements is 1 because 1 is the lowest word overlap score associated with one of the advertisements of the plurality of advertisements.

Xₘₐₓ(P,A) results in a maximum feature value associated with an advertisement of the plurality of advertisements and search query content. Continuing with the example above, the Xₘₐₓ(P,A) of the word overlap feature of the plurality of advertisements is 5 because 5 is the greatest word overlap score associated with one of the advertisements of the plurality of advertisements.

Xₘₑₐₙ(P,A) results in a mean of the feature values associated with the advertisements of the plurality of advertisements and search query content. Continuing with the example above, Xₘₑₐₙ(P,A) of the word overlap feature is 3 because 3 is the average of the word overlap scores associated with the advertisements of the plurality of advertisements.

X_{wmean}(P,A) results in a mean of the feature values associated with the advertisements of the plurality of advertisements and search query content that has been weighted based on an ad score associated with each advertisement of the plurality of advertisements. Continuing with the example above, if the first advertisement is associated with an ad score of 1, the second advertisement is associated with an ad score of 2, the third advertisement is associated with an ad score of 3, the fourth advertisement is associated with an ad score of 4, and the fifth advertisement is associated with an ad score of 5, X_{wmean}(P,A) of the word overlap feature is calculated to be 3.67.

Cosine similarity is a feature that measures a degree to which terms associated with the plurality of advertisements overlap with terms in the content of the search query, with a score that has been weighted based on a number of times a term appears in both the plurality of advertisements and the content of the search query. In one implementation, the cosine similarity feature may be calculated using the equation:

$$sim ( P , A ) = \frac{{\sum }_{t ∈ P ⋂ A} {w}_{Pt} {w}_{At}}{\sqrt{{\sum }_{t ∈ P} {w}_{Pt}^{2}} \sqrt{{\sum }_{t ∈ A} {w}_{At}^{2}}}$$

where w_{Pt} (weight with respect to search query and term) and w_{At} (weight with respect to advertisement and term) are the term frequency-inverse document frequency (tf_{idf}) weights of the term t in the search query and advertisement, respectively. The tf_{idf} weighs of terms result in terms that appear a significant number of times in the plurality of advertisements and/or the search query content being given a large weight, and terms that rarely appear in the plurality of advertisements and/or the search query content also being given a large weight. For a further discussion of tf_{idf} weights, see G. Salton and M McGill, An Introduction to Modern Information Retrieval, McGraw-Hill, 1983, ISBN 0070544840.

The tf_{idf} weight w_{Pt} of term t in the search query may be computed using the equation:

$${w}_{Pt} = tf \cdot {log}_{2} ( \frac{N + 1}{{n}_{t} + 0.5} )$$

where tf is term frequency, N is the total number of advertisements in the plurality of advertisements, and nₜ is the number of advertisements in the plurality of advertisements in which term t occurs. The weight w_{At} of term t in the plurality of advertisements may be computed in the same way.

Translation is a feature that measures a degree of topical relationship between the plurality of advertisements and the content of the search query. As explained in more detail below, to calculate a translation score, the relevance module generally computes a probability that two terms (in the same language) are associated with each other, such that one term appears in the plurality of advertisements and the other term appears in the search query content.

The translation feature indicates a degree of topical relationship between a plurality of advertisements and search query content even though the same term does not appear in both the plurality of advertisements and the content of the search query, as required by features such as word overlap and cosine similarity. For example, if the plurality of advertisements includes the term “old cars” and the content of the search query includes the term “antique automobiles,” the translation feature would indicate that the plurality of advertisements and the content of the search query are related due to the relationship between the terms “old cars” and “antique automobiles.”

It will be appreciated that when an advertisement is translated into terms to be matched with terms from the search query content, some information regarding the full meaning of the advertisement is lost. To capture the difference between terms and a full advertisement, the relevance module may build translation tables such as those described in Y. Al-Onaizan, J. Curin, M. Jahr, K. Knight, J. Lafferty, D. Melamed, F. J. Och, D. Purdy, N. A. Smith, and D. Yarowsky, Statistical Machine Translation, Final Report, JHU workshop, 1999; P. F. Brown, J. Cocke, S. A. Della Pietra, V. J. Della Pietra, F. Jelineck, J. D. Lafferty, R. L. Mercer, and P. S. Roossin, A Statistical Approach to Machine Translation, Computational Linguistics, 16(2):79-85, 1990; and P. F. Brown, S. A. Della Pietra, V. J. Della Pietra, and R. L. Mercer, The Mathematics of Statistical Machine Translation: Parameter Estimation, Computational Linguistics 19(2):263-311, 1993.

The translation tables provide a distribution of a probability of a first term translating to a second term, given an alignment between two sentences, and other information such as how likely a term is to have many other translations, the relative distance between two terms in their respective sentences, and the appearance of words in common classes of words.

As stated above, to calculate a translation score, the relevance module may compute a probability that two terms (in the same language) are associated with each other, such that one term appears in the plurality of advertisements and the other term appears in the search query content. To compute the probability, the relevance module concatenates the plurality of advertisements to form a meta-document, also known as a “source.” The relevance module also concatenates the search query content to form a second meta-document, also known as a “target.” The “source” and “target” are known collectively as a “parallel corpus.”

The relevance module determines a number of times a term in the source is associated with a term in the target, and normalizes the total number of times the term was found in the source. The relevance module then computes an alignment between the source and the target by assuming that a pair of terms with a highest probability are aligned with each other, and then aligning the remaining terms in each of the source and target sentence pairs accordingly. It should be appreciated that each term in the source may be aligned with one term in the target, but that each term in the target may be aligned with any number of terms in the source, because the relevance module iterates over source terms and looks at each term one time.

The relevance module then re-estimates a number of times a source term is associated with a target term, given the alignment described above. The above-described blocks of estimating probabilities, adjusting the alignment to maximize the probabilities, and re-estimating the probabilities are repeated until the probabilities do not change, or change only a very small amount.

In some implementations, the relevance module may improve the alignment by limiting a number of words a term in the target is allowed to translate to; by preventing words at the beginning of the source sentence from translating to words at the ends of the target sentence; and/or by grouping words together that are similar in meaning or semantic context and aligning words that appear in the same group.

The relevance module may calculate a translation score of the plurality of advertisements and the content of the search query based on factors such as an average of the translation properties of all terms in the content of the search query translating to all terms in a title and description of a candidate advertisement, or a proportion of terms in the content of a search query that have a translation in a title or description of an advertisement.

Pointwise mutual information and chi-squared are features that measure a degree of relevance between the plurality of advertisements and the content of the search query based on a co-occurrence of terms. For example, if an advertisement includes both the term “automobile” and the term “car”, and the content of a search query includes both the term “automobile” and the term “car”, because the terms “automobile” and “car” are related and appear in both the advertisement and the search query content, pointwise mutual information and chi-squared information will indicate that the advertisement and the search query content are related.

In one implementation, pointwise mutual information may be calculated using the equation:

$$PMI ( {t}_{1} , {t}_{2} ) = {log}_{2} \frac{P ( {t}_{1} , {t}_{2} )}{P ( {t}_{1} ) P ( {t}_{2} )}$$

where t₁ is a term from the search query content, t₂ is a term from an advertisement, P(t) is a probability that term t appears anywhere on the Internet, and P(t₁,t₂) is a probability that terms t₁ and t₂ occur in the same search query. In some implementations P(t) may be calculated by dividing the number of search queries that occur on the Internet where term t is present divided by the total number of search queries that occur on the Internet. Similarly, P(t₁,t₂) may be calculated by dividing the number of search queries that occur on the Internet where terms t₁ and t₂ are present divided by the total number of search query that occur on the Internet. It will be appreciated that a number of search queries that occur on the Internet may be approximated based on a number of search queries indexed by a commercial search engine.

In some implementations, the relevance module forms pairs of terms t₁ and t₂ for the pointwise mutual information calculation by extracting a top number of terms, such as the top 50 terms, based on the tf_{idf} weight of the terms in a search query.

In one implementation, chi-squared may be calculated using the equation:

$${X}^{2} = \frac{\vert L \vert {( {o}_{11} {o}_{12} - {o}_{12} {o}_{21} )}^{2}}{( {o}_{11} + {o}_{12} ) ( {o}_{11} + {o}_{21} ) ( {o}_{12} + {o}_{22} ) ( {o}_{21} + {o}_{22} )}$$

where |L| is a number of documents available on the Internet (which may be approximated based on a number of search queries indexed by a commercial search engine) and oᵢⱼ are defined in Table 1.

TABLE 1

| | t₁ | [symbol] t₁ |
|---|---|---|
| t₂ | O₁₁ | O₁₂ |
| [symbol] t₂ | O₂₁ | O₂₂ |

For example, o₁₁ stands for the number of search queries available on the Internet that contain both terms t₁ and t₂, and o₁₂ stands for the number of search queries on the Internet in which t₂ occurs but t₁ does not occur. When a relevance module calculates pointwise mutual information with respect to search queries rather than search query content, |L| is a number of search queries appearing in one or more search logs, o₁₁ stands for the number of search queries in the search logs that contain both terms t₁ and t₂, and o₁₂ stands for the number of search queries in the search logs in which t₂ occurs but t₁ does not occur. For a further discussion on a chi-squared statistical property, see Greenwood, P. E., Nikulin, M. S., A Guide to Chi-Squared Testing, Wiley, New York, 1996, ISBN 047155779X.

The relevance module computes the chi-squared statistic (X²) for each advertisement and the search query content, and counts the number of pairs of terms for which the chi-squared statistic is above a threshold, such as 95%. It will be appreciated that if the chi-squared statistic for a pair of terms is above the threshold, the pair of terms is related. Therefore, the more pairs of terms between the plurality of advertisements and the search query content that are related, the more likely it is that the plurality of advertisements and the search query content are related.

While the features described above such as word overlap, cosine similarity, translation, pointwise mutual information, and chi-squared measure a degree of relevance between the plurality of advertisements and search query content, it will be appreciated that the features described below such as bid price, coefficient of variation, and topical cohesiveness measure how related the advertisements of the plurality of advertisements are to each other.

Bid price is a feature that may indicate an overall quality of a plurality of advertisements. For example, if the advertisements of the plurality of advertisements are associated with a large bid price for a term obtained from the content of the search query, the fact that an advertiser is wiling to pay a large amount for an action associated with their advertisement is likely an indication that an advertisement is of a high quality. Therefore, the plurality of advertisements is likely of a high overall quality.

Conversely, if a number of advertisements of the plurality of advertisements are associated with a small bid price for a term obtained from the content of the search query, the fact that an advertiser is only willing to pay a small amount for an action associated with their advertisement is likely an indication that an advertisement is of a low quality. Therefore, the plurality of advertisements is likely of a low overall quality.

Coefficient of variation is a feature that measures a degree of variance of ad scores between the advertisements of the plurality of advertisements. As described above, an ad score is a value that represents a degree of relevance between an advertisement and a keyword. The relevance module typically uses coefficient of variation information instead of a standard deviation or variance information because coefficient of variation information is normalized with respect to a mean of the ad score.

In one implementation, the relevance module may calculate a coefficient of variation using the equation:

$$COV = \frac{{σ}_{SCORE}}{{μ}_{SCORE}}$$

where σ_{SCORE} is a standard deviation of the ad scores of the advertisements in the plurality of advertisements and μ_{SCORE} is a mean of the ad scores of the advertisements in the plurality of advertisements.

Topical cohesiveness is a feature that measures how topically related the advertisements of the plurality of advertisements are to each other. For example, if a term “cheap hotels” is obtained from the content of a search query and the bid phrases associated with the plurality of advertisements are “cheap cars,” “hotel discounts,” and “swimming pools,” then the plurality of advertisements have a low topical cohesiveness since they relate to very different topics. However, if the term “cheap hotels” is obtained from the content of the search query and the bid phrases associated with the plurality of advertisements are “hotel discounts,” “inexpensive hotels,” and “vacation hotels,” then the results are more topically cohesive and more likely to be satisfying to an Internet user.

Typically, if a plurality of advertisements is of a high quality, the advertisements of the plurality of advertisements will also be topically related. Conversely, if the plurality of advertisements is of a low quality, the advertisements of the plurality of advertisements are typically not topically related. However, it should be appreciated that because a plurality of advertisements may be topically related to each other, but not related to the content of a search query or a search query, the topical cohesive feature is typically used in conjunction with other features, such as the word overlap, cosine similarity, pointwise mutual information, and chi-squared features described above, to determine a degree of relevance between advertisements and the content of a search query or a search query.

To measure a topical cohesiveness of the plurality of advertisements, the relevance module may build a relevance model over terms and/or semantic classes. With respect to terms, the relevance module may first build a statistical model using the equation:

$${θ}_{w} = {\sum }_{α ∈ A} P ( w \vert A ) P ( A \vert WP )$$

where P(w|A) is a likelihood that term w is present in an advertisement, as explained below; P(A|WP) is a likelihood of an advertisement given the search query (WP), as explained below; and θ_{w} is shorthand for P(w|WP), which is a multinomial distribution over items w.

The likelihood that a term is present in an advertisement, P(w|A), may be estimated using the equation:

$$P ( w \vert A ) = \frac{{tf}_{w , A}}{\vert A \vert}$$

where tf_{w,A} is a total number of times a term w occurs in an advertisement (A) and |A| is a total number of terms in the advertisement.

The likelihood of an advertisement given a search query, P(A|WP), may be estimated using the equation:

$$P ( A \vert WP ) = \frac{SCORE ( WP , A )}{{\sum }_{{A}^{′} ∈ A} SCORE ( WP , {A}^{′} )}$$

where SCORE(WP,A) is an ad score for an advertisement given a search query. When θ_{w} is estimated using the equations described above, it is often referred to in information retrieval literature as a relevance model.

With respect to semantic classes, for each advertisement, the relevance module may generate a number of semantic classes associated with the advertisement and a score associated with the advertisement and the semantic class. As known in the art, a semantic class is a topical classification that an advertisement may relate to. Examples of semantic classes include topics such as entertainment, automobile, and sports. Further, each semantic class may include subclasses, such as golf or tennis for the semantic class sports. It will be appreciated that this hierarchy may continue such that each subclass includes further subclasses.

To calculate a relevance model based on semantic classes, the relevance module may estimate P(c|A) using the equation:

$$P ( c \vert A ) = \frac{SCORE ( c , A )}{{\sum }_{c ∈ C} SCORE ( c , A )}$$

where C is a set of semantic classes and SCORE(c,A) is a score assigned by a classifier to semantic class c for advertisement A. The resulting relevance model, θ_{c}, is a multinomial distribution of the semantic classes.

After building a relevance model over terms or classes as described above, the relevance module may measure the cohesiveness of the relevance module. For example, the relevance module may calculate a clarity score measuring a KL-divergence between the relevance model and a collection model. For a further discussion on a clarity score, please see Steve Cronen-Townsent, Yun Zhou, and W. Bruce Croft, Predicting Query Performance, Proceedings of the 25^{th} Annual International ACM SIGIR Conference on Research and Development in Information Retrieval, 299-306, 2002.

The clarity score measures how “far” the relevance model estimated from the plurality of advertisements (θ) is from the model of an entire set of advertisements (\hat{θ}) available at the ad provider, also known as an ad inventory. If the plurality of advertisements is found to be cohesive and focused on one or two topics, the relevance model will be very different from the collection model. However, if the set of topics represented by the plurality of advertisements is scattered and non-cohesive, the relevance model will be very similar to the collection model.

In one implementation, the clarity score may be calculated using the equation:

$$CLARITY ( θ ) = {\sum }_{w ∈ V} {θ}_{w} log \frac{{θ}_{w}}{{\hat{θ}}_{w}}$$

where \hat{θ} is the collection model, which is a maximum likelihood estimate computed over the entire collection of advertisements available at an ad provider, θ_{w} is the relevance model, and V is either the set of terms (for term relevance models) or the set of semantic classes (for semantic class relevance models).

The relevance model may additionally be used to calculate an entropy score. Entropy measures how “spread out” a probability distribution is. If a distribution has high entropy, then the distribution is very spread out. Conversely, if the distribution has low entropy, then the distribution is highly peaked and less spread out. By measuring the entropy of either the term relevance model or the semantic class relevance model, the entropy score measures how spread out the terms or semantic classes are with respect to the advertisements. If the entropy is high, then the term or semantic class distribution is very spread out, meaning that the advertisements are not very cohesive. However, if the entropy is low, then the term or semantic class distribution is very peaked and less spread out, meaning that the advertisements are more cohesive.

For example, if a term relevance model is built over five advertisements, where each advertisement includes the term “cars,” then the entropy of the relevance model would be 0, since the relevance model would be peaked around the term “cars” since P(cars|model)=1 and P(other words|model)=0. However, of the five advertisements, if a first advertisement includes the term “cat,” a second advertisement includes the term “dog,” a third advertisement includes the term “rabbit,” a fourth advertisement includes the term “turtle,” and a fifth advertisement includes the term “fish,” then the entropy of the relevance model would be very large, since the distribution is spread across five different terms, instead of just one.

In one implementation, the relevance module may calculate an entropy score using the equation:

$$H ( θ ) = - {\sum }_{w ∈ V} {θ}_{w} log {θ}_{w}$$

It will be appreciated that the calculation of an entropy score does not require the calculation of a background model as described above with respect to the clarity score.

In some implementations, the relevance module computes both clarity and entropy scores based on relevance models estimated from terms in an ad title, an ad description, and ad semantic classes, resulting in a total of six topical cohesiveness scores.

After extracting the set of features from the plurality of advertisements and the content of the search query at block 510, the method loops to block 500 and the above-described process is repeated for another plurality of advertisements and another search query. This process is repeated until at block 515 the relevance module generates a prediction model that may be utilized to predict whether a set of candidate advertisements is relevant to the content of a set of search queries based on the indications of relevance received from one or more human operators received at block 505 and the set of features extracted at block 510. In one implementation, the relevance module generates the prediction model using machine-learning algorithms.

Additionally, in some implementations, the relevance module may extract information from a different number of advertisements for each feature. For example, for one set of candidate advertisements, the relevance module may extract information from five advertisements of the set of candidate advertisements for the word overlap feature and extract information from ten advertisements of the set of candidate advertisements for the pointwise mutual information feature.

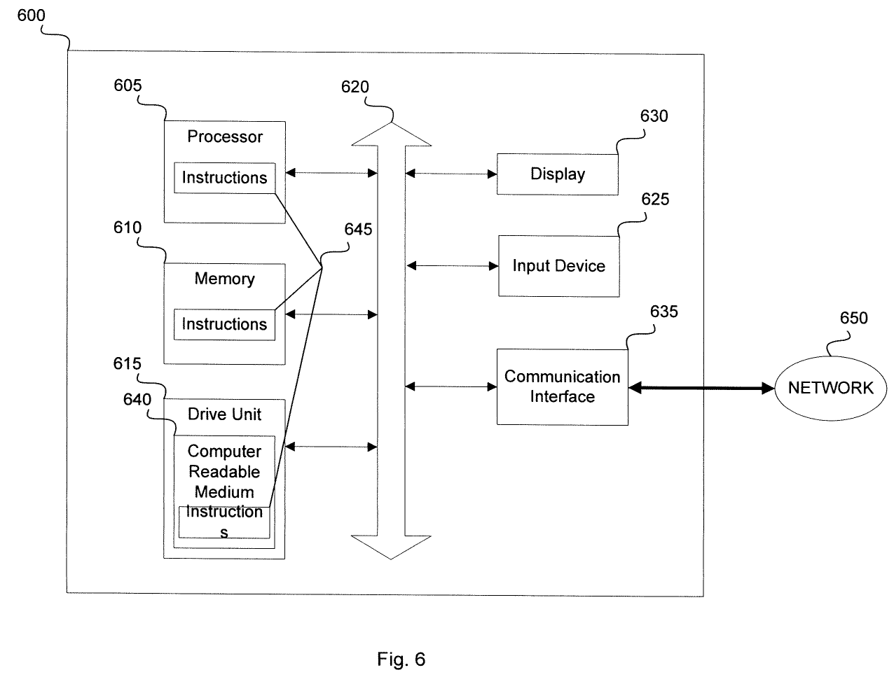

FIG. 6 illustrates a general computer system, which may represent a sponsored search web server 105, terminal 120, or any of the other computing devices referenced herein. The computer system 600 may include a set of instructions 645 that may be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 645 (sequential or otherwise) that specify actions to be taken by that machine. In one embodiment, the computer system 600 may be implemented using electronic devices that provide voice, video or data communication. Further, while a single computer system 600 may be illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 605, such as, a central processing unit (CPU), a graphics processing unit (GPU), or both. The processor 605 may be a component in a variety of systems. For example, the processor 605 may be part of a standard personal computer or a workstation. The processor 605 may be one or more general processors, digital signal processors, application specific integrated circuits, field programmable gate arrays, servers, networks, digital circuits, analog circuits, combinations thereof, or other now known or later developed devices for analyzing and processing data. The processor 605 may implement a software program, such as code generated manually (i.e., programmed).

The computer system 600 may include a memory 610 that can communicate via a bus 620. For example, the advertisement database 115 and the query rewrite database may be stored in the memory. The memory 610 may be a main memory, a static memory, or a dynamic memory. The memory 610 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 610 may include a cache or random access memory for the processor 605. Alternatively or in addition, the memory 610 may be separate from the processor 605, such as a cache memory of a processor, the system memory, or other memory. The memory 610 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 610 may be operable to store instructions 645 executable by the processor 605. The functions, acts or tasks illustrated in the figures or described herein may be performed by the programmed processor 605 executing the instructions 645 stored in the memory 610. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 600 may further include a display 630, such as a liquid crystal display (LCD), an organic light emitting diode (OLED), a flat panel display, a solid state display, a cathode ray tube (CRT), a projector, a printer or other now known or later developed display device for outputting determined information. The display 630 may act as an interface for the user to see the functioning of the processor 605, or specifically as an interface with the software stored in the memory 610 or in the drive unit 615.

Additionally, the computer system 600 may include an input device 630 configured to allow a user to interact with any of the components of system 600. The input device 625 may be a number pad, a keyboard, or a cursor control device, such as a mouse, or a joystick, touch screen display, remote control or any other device operative to interact with the system 600.

The computer system 600 may also include a disk or optical drive unit 615. The disk drive unit 615 may include a computer-readable medium 640 in which one or more sets of instructions 645, e.g. software, can be embedded. Further, the instructions 645 may perform one or more of the methods or logic as described herein. The instructions 645 may reside completely, or at least partially, within the memory 610 and/or within the processor 605 during execution by the computer system 600. The memory 610 and the processor 605 also may include computer-readable media as discussed above.

The present disclosure contemplates a computer-readable medium 640 that includes instructions 645 or receives and executes instructions 645 responsive to a propagated signal; so that a device connected to a network 650 may communicate voice, video, audio, images or any other data over the network 650. The instructions 645 may be implemented with hardware, software and/or firmware, or any combination thereof. Further, the instructions 645 may be transmitted or received over the network 650 via a communication interface 635. The communication interface 635 may be a part of the processor 605 or may be a separate component. The communication interface 635 may be created in software or may be a physical connection in hardware. The communication interface 635 may be configured to connect with a network 650, external media, the display 630, or any other components in system 600, or combinations thereof. The connection with the network 650 may be a physical connection, such as a wired Ethernet connection or may be established wirelessly as discussed below. Likewise, the additional connections with other components of the system 600 may be physical connections or may be established wirelessly.

The network 650 may include wired networks, wireless networks, or combinations thereof. Information related to business organizations may be provided via the network 650. The wireless network may be a cellular telephone network, an 802.11, 802.16, 802.20, or WiMax network. Further, the network 650 may be a public network, such as the Internet, a private network, such as an intranet, or combinations thereof, and may utilize a variety of networking protocols now available or later developed including, but not limited to TCP/IP based networking protocols.

The computer-readable medium 640 may be a single medium, or the computer-readable medium 640 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 640 may include a solid-state memory such as a memory card or other package that houses one or more non-volatile read-only memories. The computer-readable medium 640 also may be a random access memory or other volatile re-writable memory. Additionally, the computer-readable medium 640 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

From the foregoing, it may be seen that the embodiments disclosed herein provide an approach for predicting a degree of relevance between query rewrites and a search query. By using a relevance model to predict a degree of relevance between the query rewrites and search query before serving advertisements, an ad provider is able to more accurately serve relevant advertisements.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

We claim:

1. A method for predicting a degree of relevance between search queries, the method comprising:
receiving a search query;
identifying a candidate query rewrite associated with the search query;
extracting a first set of features from advertisements associated with the candidate query rewrite and the search query;
determining a first degree of relevance between the advertisements associated with the candidate query rewrite and the search query based on the first set of features and a second set of features extracted from advertisements and query terms of known relevance; and
determining a second degree of relevance between the candidate query rewrite and the search query based on the first degree of relevance between the advertisements associated with the candidate query rewrite and the search query.

2. The method according to claim 1, wherein the first degree of relevance corresponds to an average relevance between the advertisements associated with the candidate query rewrite and the search query.

3. The method according to claim 1, further comprising serving advertisements associated with the query rewrite that have a second degree of relevance higher than a threshold.

4. The method according to claim 1, further comprising determining a third degree of relevance between advertisements associated with the query rewrite that have a second degree of relevance higher than a first threshold and the search query, and serving those advertisements that have a third degree of relevance higher than a second threshold.

5. The method of claim 1, wherein extracting the first set of features comprises:
determining a degree to which terms associated with the advertisements associated with the candidate query rewrite overlaps with terms in the search query.

6. The method of claim 1, wherein extracting the first set of features comprises:
determining a degree to which terms associated with the advertisements associated with the candidate query rewrite overlaps with terms in the search query, weighted based on a number of times a term appears in both the advertisements associated with the candidate query rewrite and the first search query.

7. The method of claim 1, wherein extracting the first set of features comprises:
determining a degree of relevance between the advertisements associated with the candidate query rewrite and the search query based on the co-occurrence of a first term and a second term, which is different from the first term but is related to the first term, in the advertisements associated with the candidate query rewrite and the first search query.

8. The method of claim 1, wherein extracting the first set of comprises:
determining a quality of the advertisements associated with the candidate query rewrite based on a bid price associated with two or more advertisements of the advertisements associated with the candidate query rewrite.

9. The method of claim 1, wherein extracting the first set of features comprises:
determining a quality of the advertisements associated with the candidate query rewrite based on a coefficient of variation of an ad score associated with two or more advertisements of the advertisements associated with the candidate query rewrite.

10. The method of claim 1, wherein extracting the first set of comprises:
determining a quality of the advertisements associated with the candidate query rewrite based on a degree of topical cohesiveness of two or more advertisements of the advertisements associated with the candidate query rewrite.

11. The method of claim 10, wherein determining a quality of the advertisements associated with the candidate query rewrite based on a degree of topical cohesiveness of two or more advertisements of the advertisements associated with the candidate query rewrite comprises:
building a relevance model over at least one of terms or semantic classes associated with two or more advertisements of the advertisements associated with the candidate query rewrite; and
determining a clarity score for the advertisements associated with the candidate query rewrite based on a difference between the relevance model and a model of an ad inventory of an ad provider.

12. The method of claim 10, wherein determining a quality of the advertisements associated with the candidate query rewrite based on a degree of topical cohesiveness of two or more advertisements of the advertisements associated with the candidate query rewrite comprises:
building a relevance model over at least one of terms or semantic classes associated with two or more advertisements of the advertisements associated with the candidate query rewrite; and
determining an entropy score for the advertisements associated with the candidate query rewrite based on a probability distribution of the terms or semantic classes over which the relevance model was built.

13. A machine-readable storage medium having stored thereon, a computer program comprising at least one code section for predicting a degree of relevance between search queries, the at least one code section being executable by a machine for causing the machine to perform acts of:
receiving a search query;
identifying a set of candidate query rewrites associated with the search query;
extracting a set of features from advertisements associated with the set of candidate query rewrites and the search query;
determining a degree of relevance between the advertisements associated with the set of candidate query rewrites and the search query based on a prediction model and the set of features extracted from the advertisements associated with the set of candidate query rewrites and the search query; and
determining a degree of relevance between the set of candidate query rewrites and the search query based on the determined degree of relevance between the advertisements associated with the set of candidate query rewrites and the search query receiving a search query;
identifying a candidate query rewrite associated with the search query;
extracting a first set of features from advertisements associated with the candidate query rewrite and the search query;
determining a first degree of relevance between the advertisements associated with the candidate query rewrite and the search query based on the first set of features and a second set of features extracted from advertisements and query terms of known relevance; and
determining a second degree of relevance between the candidate query rewrite and the search query based on the first degree of relevance between the advertisements associated with the candidate query rewrite and the search query.

14. The machine-readable storage medium according to claim 13, the first degree of relevance corresponds to an average relevance between the advertisements associated with the candidate query rewrite and the search query.

15. The machine-readable storage medium according to claim 13, wherein the at least one code section comprises code that enables serving advertisements associated with the query rewrite that have a second degree of relevance higher than a threshold.

16. The machine-readable storage medium according to claim 13, wherein the at least one code section comprises code that enables determining a third degree of relevance between advertisements associated with the query rewrite that have a second degree of relevance higher than a first threshold and the search query, and serving those advertisements that have a third degree of relevance higher than a second threshold.

17. A system for predicting a degree of relevance between search queries, the system comprising:
a receiver operative to receive a search query;
identification circuitry operative to identify a candidate query rewrite associated with the search query; and
a relevance module operative to extract a first set of features from advertisements associated with the candidate query rewrite and the search query, determine a first degree of relevance between the advertisements associated with the candidate query rewrite and the search query based on the first set of features and a second set of features extracted from advertisements and query terms of known relevance, and determine a second degree of relevance between the candidate query rewrite and the search query based on the first degree of relevance between the advertisements associated with the candidate query rewrite and the search query.

18. The system according to claim 17, wherein the first degree of relevance corresponds to an average relevance between the advertisements associated with the candidate query rewrite and the search query.

19. The system according to claim 17, wherein the relevance module is operative to serve advertisements associated with the query rewrite that have a second degree of relevance higher than a threshold.

20. The system according to claim 17, wherein the relevance module is operative to determine a third degree of relevance between advertisements associated with the query rewrite that have a second degree of relevance higher than a first threshold and the search query, and serving those advertisements that have a third degree of relevance higher than a second threshold.

21. A system for predicting a degree of relevance between search queries, the system comprising:
means for receiving a search query;
means for identifying a candidate query rewrite associated with the search query; and
means for extracting a first set of features from advertisements associated with the candidate query rewrite and the search query;
means for determining a first degree of relevance between the advertisements associated with the candidate query rewrite and the search query based on the first set of features and a second set of features extracted from advertisements and query terms of known relevance; and
means for determining a second degree of relevance between the candidate query rewrite and the search query based on the first degree of relevance between the advertisements associated with the candidate query rewrite and the search query.
